(19) United States
(12) Patent Application Publication
(10) Pub. No.: US 2003/0116653 A1
(43) Pub. Date: Jun. 26, 2003

(54) Fuel injector tip

(76) Inventors: Jeffrey J. Doll, Lasalle, IL (US); Sunil T. Kumar, Bloomington, IL (US); Vladimir Theodorof, Bloomington, IL (US)

Correspondence Address: CATERPILLAR INC., 100 N.E. ADAMS STREET, PATENT DEPT., PEORIA, IL, 616296490

(21) Appl. No.: 10/036,965

(22) Filed: Dec. 21, 2001

(51) Int. Cl. F02M 39/00

(52) U.S. Cl. 239/533.12; 239/533.3

(57) ABSTRACT

A fuel injector comprising a body and an injector tip is provided. The injector tip includes a barrel having a first end, a second end, an outer wall and a cavity extending from the first end toward the second end. An end portion is disposed at the second end, the end portion includes a sac portion and an end surface. A radius or chamfer is interposed the end surface and the outer wall. A plurality of nozzles are disposed in the sac portion at a predetermined angle and the end surface is defined substantially parallel to the plurality of nozzles.

### TECHNICAL FIELD

This invention relates generally to a fuel system for an internal combustion engine and more specifically to a tip for a fuel injector, as used with a diesel engine.

### BACKGROUND

Manufacturers of internal combustion engines are continuously attempting to improve the efficiency and emissions output of internal combustion engines. In diesel engines, a large amount of research has been done to reduce NOx output of an engine, through the use of improved fuel injectors and injection control. An injector tip typically includes a sac portion defined by an internal nozzle chamber and a exterior portion protruding from the end of the tip. A plurality of nozzle openings extend from a sac chamber through the sac to outer sac wall. High pressure fuel is forced into the sac chamber and then sprays into the combustion chamber. Often the spray of fuel does not mix evenly with combustion air within the cylinder. This creates uneven temperatures within the cylinder and causes inconsistent burning, resulting in possible emissions fluctuations.

In effort to improve combustion and reduce emissions, tip geometry may be altered to improve atomization and distribution of the spray pattern within the combustion chamber. An improved spray distribution increases mixing of fuel and combustion air, in turn creating more even temperatures throughout the cylinder.

Many manufacturers have altered geometry of injector tips in effort to improve efficiency and emissions of engines. U.S. Pat. No. 4,106,702 issued to Gardner et al illustrates a common tip and nozzle arrangement. Although designs similar to this are still being used, attempts to improve distribution of fuel spray in the combustion cylinder continue.

The present invention is directed to overcoming one or more of the above identified problems.

### SUMMARY OF THE INVENTION

The present invention provides an internal combustion engine having a fuel injector defined about a longitudinal axis. A fuel injector tip having a barrel portion with a first end, a second end, an outer wall and a cavity being defined about the longitudinal axis. The cavity includes an inner wall extending from the first end toward the second end. A sac portion is disposed at the second end and includes a sac chamber extending from the cavity and an outer sac surface is disposed at the second end. At least one nozzle opening extends from the sac chamber to the outer sac surface. An end surface extends radially outward from the sac surface, an obtuse angle is defined between the longitudinal axis and the end surface.

### BRIEF DESCRIPTION OF THE DRAWINGS

FIG. 1 is a diagrammatic sectional illustration of an internal combustion engine employing the present invention.

FIG. 2 is an enlarged diagrammatic sectional illustration of an embodiment of the injector tip of the present invention.

FIG. 3 is an enlarged partial diagrammatic sectional illustration of the injector tip of FIG. 2.

### DETAILED DESCRIPTION

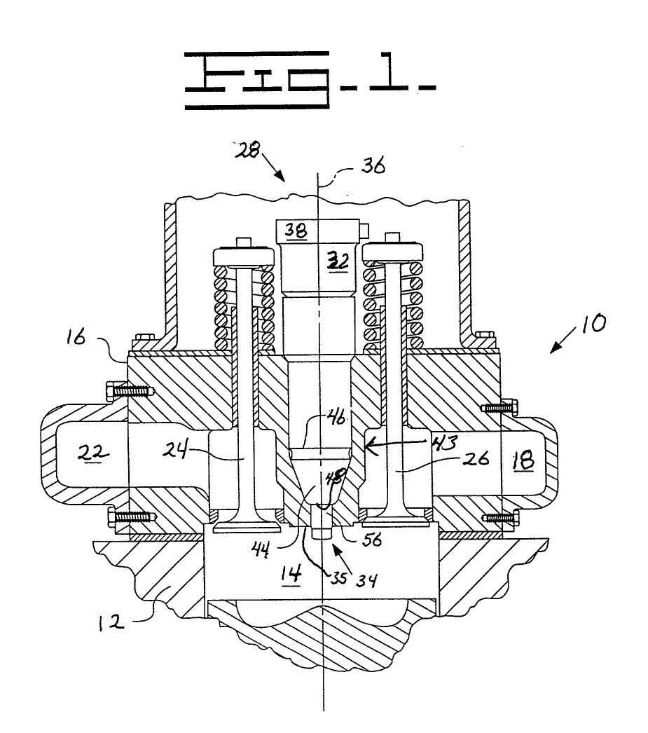

Referring to FIG. 1 an engine 10 includes a block 12 having a plurality of cylinders 14 therein, of which only one is shown, and a cylinder head 16 includes and exhaust passage 18 and an intake passage 22. An intake valve 24 is interposed the intake passage 22 and the cylinder 14. An exhaust valve 26 is interposed the exhaust passage 18 and the cylinder 14. A fuel injector 28 having a body 32 and an injector tip 34 is additionally positioned within the cylinder head 16. The injector tip 34 protrudes slightly below the surface 35 of the cylinder head 16. The fuel injector 28 is substantially of conventional construction, such as the type used with a hydraulically actuated electronically controlled unit injector system.

The fuel injector 28 is defined about a longitudinal axis 36, the body 32 includes an upper end 38, and a lower end 42 adapted to receive an attachment sleeve 44. The attachment sleeve 44 defines a substantially cylindrical member having an open end 46 and a partially open end 48, opposite the open end 46. The injector tip 34 is positioned within the attachment sleeve 44, such that a portion of the tip 34 protrudes from the attachment sleeve 44. The attachment sleeve 44, in turn, is secured to the lower end 43 of the body 32.

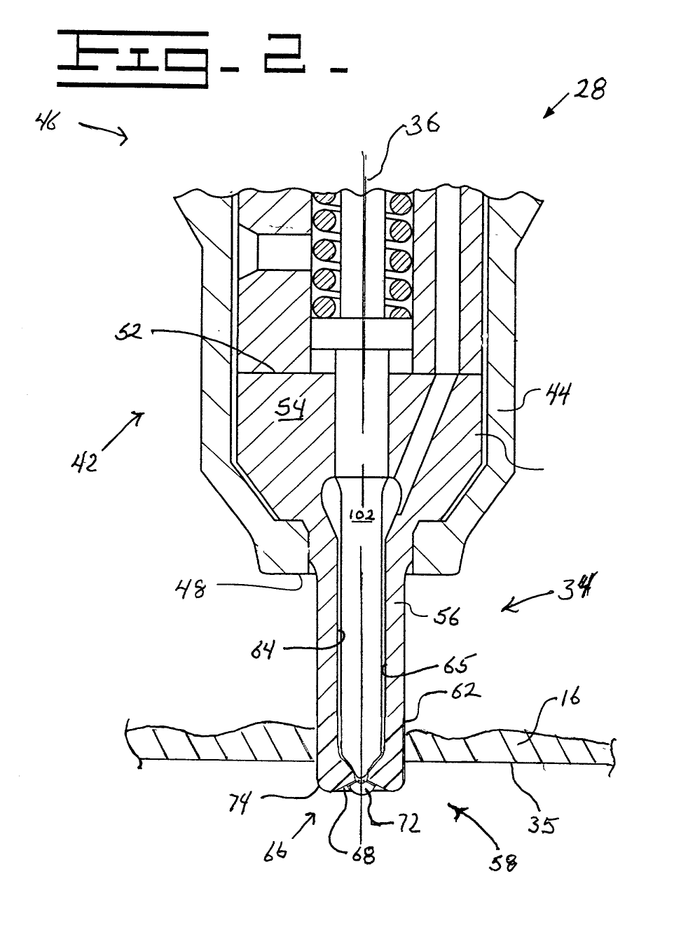

Referring now to FIG. 2, a injector tip 34 attached to the lower end 42 of a fuel injector 28 is shown. The injector tip 34 includes a substantially cylindrical member disposed about the longitudinal axis 36. A first end 52 of the injector tip 34 includes a shoulder portion 54 that is received by the attachment sleeve 44. A barrel 56 extends from the shoulder portion 54 toward a second end 58. The barrel 56 includes an outer wall 62 that extends to the second end 58. A cavity 64 defining an inner wall 65 is disposed about the longitudinal axis 36, opening at the first end 52 and extending toward the second end 58.

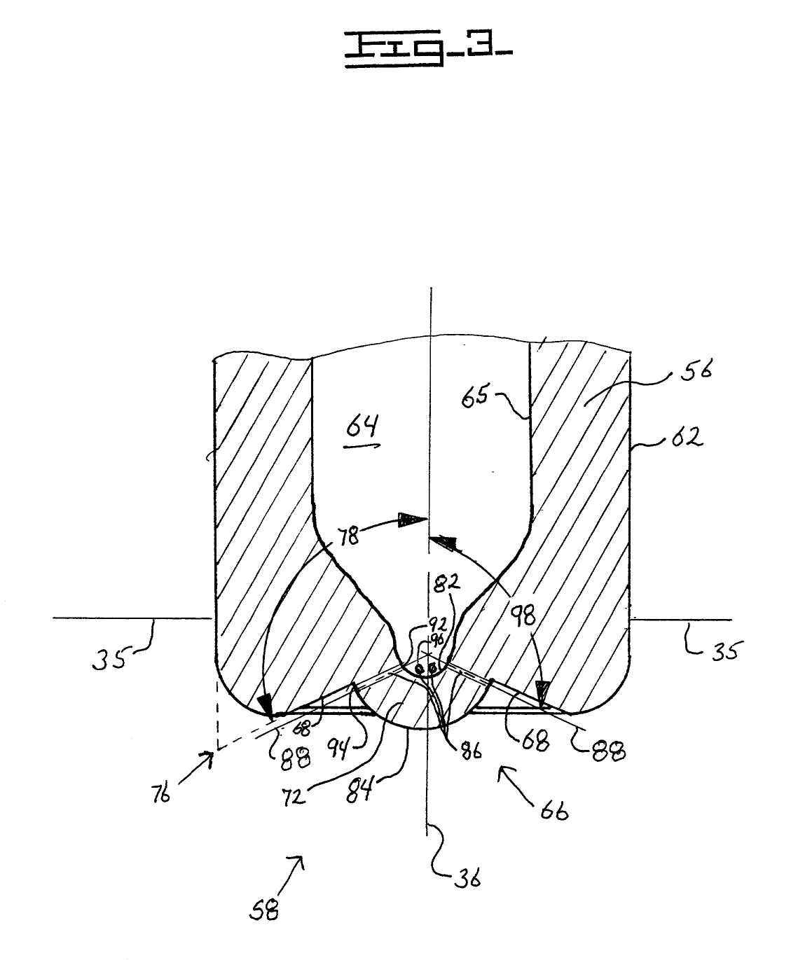

An end portion 66 is disposed at the second end 58 of the injector tip 34. The end portion 66 includes an end surface 68 and a sac portion 72. The end surface 68 is disposed about the longitudinal axis 36 and extends radially outward to the outer wall 62. A radius 74 may be interposed the end surface 68 and the outer wall 62 of the injector tip 34. Alternative of the radius 74, a chamfer (not shown) may be provided. An intersection 76 (shown in FIG. 3) is defined at the junction of the end surface 68 and the outer wall 68. An angle 78 is defined between the end surface 68 and the longitudinal axis 36. Measuring the angle 78 from a point between the first end 62 and the end surface 68, an obtuse angle is defined.

Referring now to FIG. 3, the sac portion 72 includes a sac chamber 82, an outer sac surface 84 and a plurality of nozzle openings 86. The sac chamber 82 joins the cavity near the end portion 68. The outer sac surface 84 is spherical in shape and disposed a predetermined distance from the sac chamber 82. The plurality of nozzle openings 86, each include a central axis 88, an inner end 92 joining the sac chamber 82, and an outer end 94 at the outer sac surface 84. A perimeter 92 is defined about the outer end 88 of each nozzle opening 86. A second angle 98 is defined between the longitudinal axis 36 and the central axis 88 of each nozzle opening 86. The second angle 98 substantially equal to the first predetermined angle 78. The nozzle opening 86 is adapted to spray high pressure fuel in an outward pattern, or plume.

A needle valve 102 is moveably positioned within the cavity 64. The needle valve 102 is and moveable between a first position, and a second position shown in FIG. 2. In the first position the needle valve 102 permits fluid flow from the cavity 64, through the nozzle openings 86, and into the cylinder 14. In the second position the needle valve 102 blocks fluid flow from the cavity 64.

Industrial Applicability

In operation the fuel injector tip 34 of the present invention provides improved distribution of fuel within the engine cylinder 14. High pressure fuel is supplied to the cavity 64 of the fuel injector tip 34 in a conventional manner. When the needle valve 102 is moved to the first position, fuel flows from the sac chamber 82 through the nozzle openings 86 and sprays into the cylinder 14. Action of the high pressure fuel passing through the nozzle openings 86 causes the fuel to atomize into a fine mist or spray. The fuel spray is in very close proximity to the end surface 68 of the injector tip 34.

A well known physical principle, the “Coanda Effect”, illustrates; that a stream of fluid flowing from a nozzle, along a solid surface, tends to follow the solid surface. This principle is consistent even though the surface may curve slightly from the stream.

Because of the “Coanda Effect” as fuel exits nozzle openings 86, a portion of the spray nearest the end surface 68 follows that surface. That portion of spray, travels not only in the direction of the nozzle openings 86, but is directed along the radius 74, toward the cylinder head 16. By directing fuel spray toward the cylinder head 16, greater fuel distribution and mixing of fuel and combustion air is achieved.

Other aspects, objects and advantages of this invention can be obtained from study of the drawings, disclosure and the appended claims.

What is claimed is:

1. A fuel injector tip defined about a longitudinal axis, said tip including a barrel portion with a first end, a second end portion, an outer wall and a cavity, said cavity having an inner wall extending from the first end of said barrel toward the second end of said barrel; said fuel injector tip comprising:
a sac portion disposed about said longitudinal axis at said second end of said barrel, said sac portion including a sac chamber extending from said cavity and an outer sac surface disposed on said second end portion, said sac chamber having at least one nozzle opening, said nozzle opening extending from said sac chamber to said outer sac surface, said nozzle opening having an inner end and an outer end, said outer end of said nozzle opening defining a perimeter, said perimeter including a point nearest said first end of said barrel;
said second end portion having an end surface extending radially outward from said outer sac surface at a position between said first end of said barrel and said point of said perimeter; and
an angle being formed between said longitudinal axis and said end surface, said angle being measured between said first end and an intersection of said end surface and said outer wall, said angle being an obtuse angle.

2. The fuel injector tip of claim 1 wherein said obtuse angle is between 91 degrees and 120 degrees.

3. The fuel injector tip of claim 1, said end surface being substantially conical.

4. The fuel injector tip of claim 1 wherein said end portion includes a radius between said end surface and said outer wall of said barrel.

5. The fuel injector tip of claim 1 wherein said end portion includes a chamfer between said end surface and said outer wall of said barrel.

6. The fuel injector tip of claim 1, said sac portion having a substantially spherical outer surface.

7. An internal combustion engine having a fuel injector defined about a longitudinal axis, said fuel injector having a tip including a barrel portion with a first end, a second end portion, an outer wall and a cavity, said cavity having an inner wall extending from the first end of said barrel toward the second end of said barrel, said internal engine comprising:
a sac portion disposed about said longitudinal axis at said second end of said barrel, said sac portion including a sac chamber extending from said cavity and an outer sac surface disposed on said second end portion, said sac chamber having at least one nozzle opening, said nozzle opening extending from said sac chamber to said outer sac surface, said nozzle opening having an inner end and an outer end, said outer end of said nozzle opening defining a perimeter, said perimeter including a point nearest said first end of said barrel;
said second end portion having an end surface extending radially outward from said outer sac surface at a position between said first end of said barrel and said point of said perimeter; and
an angle being formed between said longitudinal axis and said end surface, said angle being measured between said first end and an intersection of said end surface and said outer wall, said angle being an obtuse angle.

8. The internal combustion engine of claim 7 wherein said obtuse angle is between 91 degrees and 120 degrees.

9. The fuel injector tip of claim 7, said end surface being substantially conical.

10. The fuel injector tip of claim 7 wherein said end portion includes a radius between said end surface and said outer wall of said barrel.

11. The fuel injector tip of claim 7 wherein said end portion includes a chamfer between said end surface and said outer wall of said barrel.

12. The fuel injector tip of claim 7, said sac portion having a substantially spherical outer surface.
